(19) United States
(12) Patent Application Publication
(10) Pub. No.: US 2006/0263898 A1
(43) Pub. Date: Nov. 23, 2006

(54) Perfume delivery systems based on inorganic nano particles

(76) Inventors: Walter Paget, Geneva (CH); Otto Grather, Carouge (CH); Ralph Nonninger, Saarbruecken (DE); Christian Goebbert, Blankenburg (DE); Rainer Wittmer, Zweibruecken (DE)

Correspondence Address: WINSTON & STRAWN LLP, 1700 K STREET, N.W., WASHINGTON, DC, 20006, US

(21) Appl. No.: 11/416,493

(22) Filed: May 1, 2006

Related U.S. Application Data
(63) Continuation of application No. PCT/IB04/03539, filed on Oct. 27, 2004.

(30) Foreign Application Priority Data
Oct. 29, 2003 (WO) PCT/IB03/04786

(51) Int. Cl. G01N 31/22

(52) U.S. Cl. 436/166; 977/773

(57) ABSTRACT

Nano-sized delivery systems consisting of an inorganic nano particle moiety covalently bonded to at least one organic pro-perfume or pro-drug moiety are disclosed. The systems of the invention are able to deliver perfuming or pharmaceutical active ingredients. Other aspects of the present invention include the use of such systems in perfumery as well as the perfuming compositions or perfumed articles that incorporate these delivery systems.

### CROSS-REFERENCE TO RELATED APPLICATIONS

This application is a continuation of International application PCT/IB2004/003539 filed Oct. 27, 2004, the entire content of which is expressly incorporated herein by reference thereto.

### TECHNICAL FIELD

The present invention relates to the field of the chemical delivery systems, and more precisely to the perfumery and pharmaceutical fields. The invention concerns a delivery system which comprises a nano particle moiety and a releasing moiety. The invention's delivery system is capable of liberating in a controlled manner an active compound belonging to the α,β-unsaturated ketone, aldehyde or carboxylic ester families.

### BACKGROUND

Inorganic materials have been described in the prior art as useful carriers for active ingredients. In particular silica has been widely disclosed as carrier for perfumes or perfume precursors, also referred to as “pro-perfumes”. For instance WO 01/83398 discloses a delivery system consisting of porous silica carrying pro-perfumes. According to this document, the pro-perfumes are either adsorbed in silica pores, or chemically bonded after chemical modification of the pores' surface. Although the size of the silica particles is not specifically cited in this document, it can be deduced from the description of silica pores that the systems are certainly on a micron scale. As a consequence, the particles are not able to form solid suspensions in a liquid. Moreover, when used in application such as in a cleaning or detergent product, due to their size, the disclosed delivery systems present the risk of leaving residues on the treated surfaces, for instance a fabric in the case of a detergent. Finally, these systems also present stability problems, as the pro-perfumes adsorbed within the pores of the inorganic material are susceptible to diffuse in the environment during a prolonged storage. To the best of our knowledge, systems based on other inorganic materials do not solve these problems.

The present invention now provides a solution to the above-mentioned problems, thanks to a delivery system which is on a nanosize scale and which comprises an inorganic nano particle moiety covalently bonded to at least one organic releasing moiety. This covalent bonding allows a better stability during storage, as well as a better control of the release of the perfume. On the other hand the nano-size of the particles allows using the delivery systems of the invention in the form of solid dispersions in a liquid.

Systems on a nanosize scale have been described in the prior art. In particular WO 02/50230 or yet DE 19841147 disclose “nano” systems. However the latter documents are based on the use of organic carriers, i.e. polymers or oligomers dissolved in one phase. These carriers are therefore dispersed in water so as to form nanoemulsions. The problems encountered by these systems come from the fact that a nanoemulsion is a liquid system which is, by virtue of its nature, susceptible of being destabilized easily when used in an application, for instance in the presence of a surfactant system. In particular, coalescence, and ripening may be cited as examples of such destabilization phenomena and they consequently alter the nanometric distribution of the emulsion system. The present invention provides a solution to the problem with the use of an inorganic carrier such as SiO₂, which is modified in its surface so as to be covalently bonded with organic moiety such as pro-perfumes. Contrary to the cited prior art the inorganic nature of the carrier allows to prepare solid dispersions which are much more stable than emulsion-type systems and which present, as a consequence, a stable nanometric distribution.

### SUMMARY OF THE INVENTION

The present invention now relates to delivery systems for perfumery or pharmaceutical applications (for instance) which are based on modified nano particles.

The present invention concerns also the use of the delivery system as perfuming ingredient as well as the perfuming compositions or perfumed articles that include these delivery systems. Other embodiments of the invention are pharmaceutical compositions or drugs that incorporate these delivery systems.

### DETAILED DESCRIPTION OF THE PREFERRED EMBODIMENTS

We have therefore surprisingly discovered that a delivery system comprising a nano particle moiety covalently bonded to at least one β-oxy, β-thio or β-amino carbonyl moiety is a valuable perfuming or therapeutical ingredient capable of liberating in a controlled manner an active compound.

Furthermore, as “active compound” we mean here a compound capable of bringing a benefit into the surrounding environment into which is it released by the invention's delivery system. The benefit could be related to an olfactif effect, e.g. an odor, or to a therapeutical effect. Therefore, the “active compound” can be an active perfuming ingredient or an active therapeutical ingredient.

In the present invention the active compound is an active α,β-unsaturated ketone, aldehyde or carboxylic ester, preferably an active α,β-unsaturated ketone or aldehyde.

In a first embodiment of the invention, the active compound is a perfuming ingredient. By “perfuming ingredient” it is meant here a compound, which is of current use in the perfumery industry, i.e. a compound which is used as active ingredient in perfuming preparations or compositions in order to impart a hedonic effect. In other words such an ingredient, to be considered as being a perfuming one, must be recognized by a person skilled in the art of perfumery as being able to impart or modify in a positive or pleasant way the odor of a composition, and not just as having an odor.

In a second embodiment of the invention, the active compound is a therapeutical ingredient. By “therapeutical ingredient” it is meant here a compound, which is of current use in the pharmaceutical industry, i.e. a compound which is incorporated into a pharmaceutical preparation, as active ingredient, to treat a disease or pain. In other words such an ingredient, to be considered as being a therapeutical one, must be recognized by a person skilled in the art of pharmacy as being able to provide a positive effect to the health of a patient.

As mentioned above, the delivery system of the invention comprises a nano particle moiety. The moiety constitutes the inorganic part of the invention's delivery system and is a mono or multi radical, depending on the number of releasing moieties bonded to it. The moiety is derived from an inorganic nano particle. By “nano particle” we mean here a particle having a mean particle size comprised between 2 nm and 500 nm, measured with the Microtrac Ultrafine Particle Analyser (UPA). Preferably the size is comprised between 15 nm and 50 nm.

The inorganic nano particle, from which the nano particle moiety can be derived, can be made from inorganic materials such as amorphous or crystalline metal oxides, hydroxides, oxo-hydroxides or mixtures thereof. Suitable examples of such metals are elements of the I, II, III or IV main group, e.g. Al, Si, In, Sn, Ca, Ba or Sr, or yet the transition elements, e.g. Ti, Zr, Fe, Ag or Zn.

Particularly suitable nano particle moieties are those derived from a nano particle made from oxides or hydroxides of Ti, Si, Zr, Al, Fe or mixtures thereof. More specifically, for their use in perfumery, the nano particles moieties made from oxides or hydroxides of Si, e.g. silica, are especially suitable for the purpose of the invention, whereas for a pharmaceutical application, it is preferable to use Si or Fe based nano particle moieties.

According to a particular embodiment of the invention the nano particle, from which the nano particle moiety is derived, has X-ray diffraction characteristics, measured with a Siemens D500 X-ray diffractometer with Cu-Kα radiation and scintillation counter, in the 2θ range between 15° and 85°. The 2θ range indicates that the spherical nano particles made of silica are mainly amorphous.

Density can also be used to characterise the nano particles. For instance a nano particle made from silica may have a density comprised between 2 and 2.4 g/cm³, preferably between 2.2 and 2.3 g/cm³, while a nano particle made from titanium oxide may have a density ranging from 3.8 to 4.3 g/cm³, preferably from 3.8 to 3.9 g/cm³, or yet the nano particle made from alumina may have a density ranging from 3.8 to 4.2 g/cm³. Alternatively a nano particle made from iron oxide may have a density comprised between 5.0 and 6.0 g/cm³.

In the case of a nano particle made from silica, which represents a preferred embodiment of the invention, the specific surface area, as measured by He-gas pycnometer AccuPyc 1330 from Micromeritics, is comprised between approximately 20 and 200 m²/g, preferably between 40 and 60 m²/g. Moreover, the surface charge of the particle is negative and the Zeta potential, measured with Malvern Zetasizer 2000, does not reveal no-charge point in the range from pH 2 to pH 11.

This inorganic nano particle moiety is covalently bonded by means of n (Si—O)— bonds to at least one releasing moiety of formula
(P—X)ₘ—R—Si(OR⁵)₃₋ₙ(O→)ₙ (I)
wherein the arrow indicates the location of the bond between the releasing moiety and the nano particle moiety, n representing an integer comprised between 1 to 3, and wherein
a) P represents a group derived from a active perfume ingredient and which is represented by formula (II) 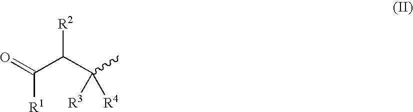
   in which the wavy line indicates the location of the bond between the P and X;
   R¹ represents a hydrogen atom, a C₁ to C₆ alkoxyl radical or a C₁ to C₁₅ linear or branched or cyclic alkyl, alkenyl or alkadienyl group, optionally substituted by one to four C₁ to C₄ alkyl groups; and
   R², R³ and R⁴ represent a hydrogen atom, a C₆₋₈ aromatic ring or a C₁ to C₁₅ linear, cyclic or branched alkyl, alkenyl or alkadienyl group, optionally substituted by one to four C₁ to C₄ alkyl groups; two, or three, of the R¹ to R⁴ being optionally bonded together to form a saturated or unsaturated ring having 6 to 20 carbon atoms and including the carbon atom to which the R¹, R², R³ or R⁴ groups are bonded, this ring being optionally substituted by one to four C₁ to C₄ linear or branched alkyl or alkenyl groups;
   or P represents a group derived from an active therapeutical steroid and is represented by formula 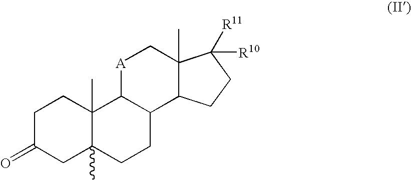
   in which the wavy line indicates the location of the bond between the P and X;
   R¹⁰ represents a hydrogen atom or a hydroxy group;
   A represents a CH₂, C═O or CH₂OH group; and
   R¹¹ represents a hydrogen atom or a C≡CH, CH₃CO or HOCH₂CO group;
b) X represents a functional group selected from the group consisting of the formulae i) to vi): 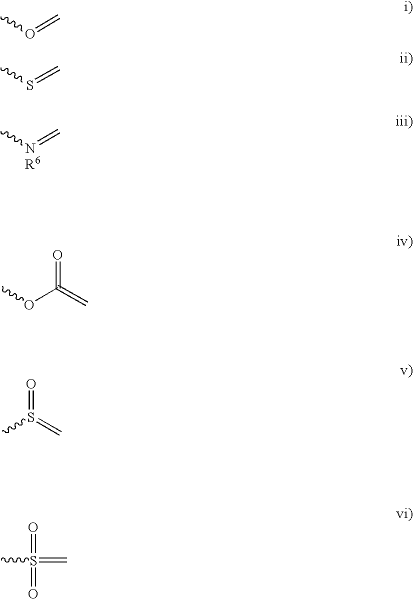
   in which formulae the wavy lines are as defined previously and the bold lines indicate the location of the bond between the X and R, and R⁶ represents a hydrogen atom or a C₁ to C₄ alkyl group;
c) R represents a linear, branched or cyclic multivalent group (with a m+1 valence) derived from a C₁-C₁₅ alkyl or alkylaryl group, the group optionally containing one or two functional groups selected from the group consisting of oxygen and sulfur atoms, CO, COO, CONR⁶, COS and N(R⁶)ₐ, R⁶ being defined as above and a representing 0 or 1,
d) R⁵ represents a linear or branched C₁ to C₄ alkyl group; and
e) m represents 1, 2 or 3.

According to a first embodiment of the invention, P in formula (I) is a group derived from an active perfuming α,β-unsaturated ketone, aldehyde or carboxylic ester having from 8 to 20 carbon atoms, or more preferably between 11 and 15 carbon atoms. According to a second embodiment, P is a group derived from a therapeutic α,β-unsaturated steroid having from 19 to 26 carbon atoms, or more preferably between 19 and 21 carbon atoms.

According to a particular mode of realisation of the first embodiment of the invention, i.e. when the active compound is a perfuming ingredient, the invention's delivery system will preferably comprise a releasing moiety (I) wherein P is a group selected from the group consisting of the formulae (P-1) to (P-12) 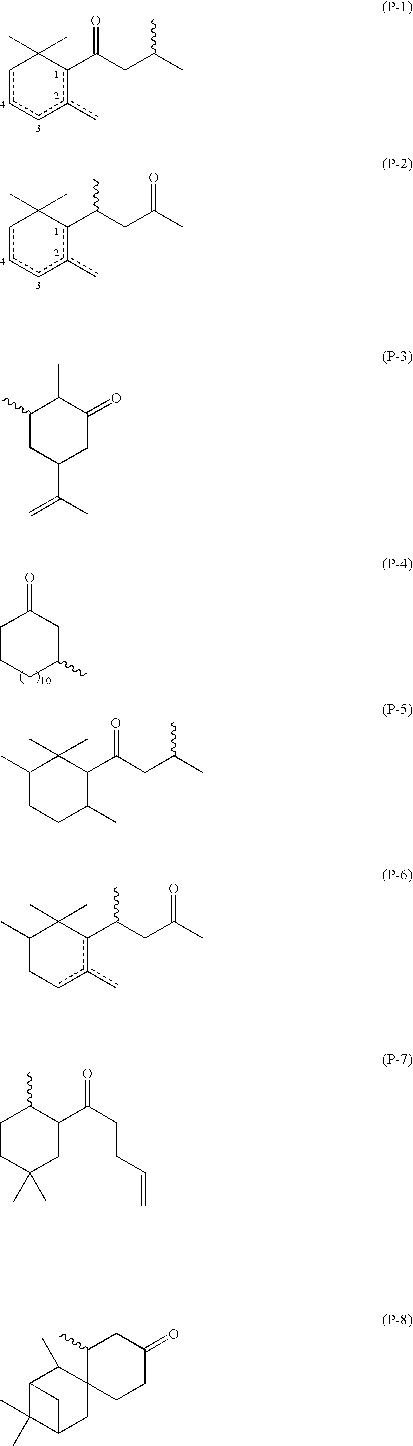 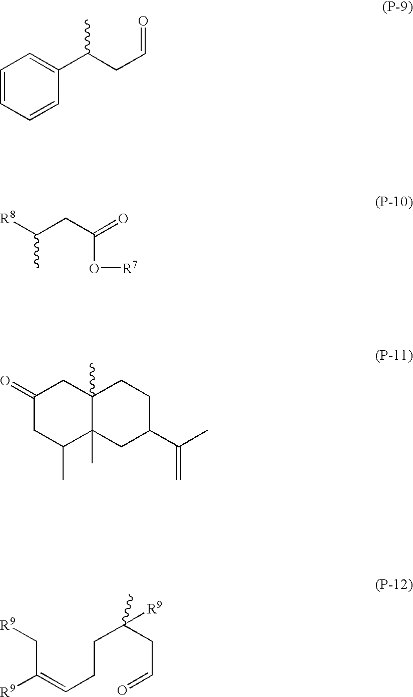
in the form of any one of their isomers, and wherein the dotted lines represent a single or double bond, R⁷ represents a methyl or ethyl group, R⁸ represents a C₆ to C₉ linear or branched alkyl, alkenyl or alkadienyl group and R⁹ represents a hydrogen atom or a methyl group, and the wavy lines have the meaning defined previously.

In a more particular realization of the mode, there will be used a releasing moiety (I) wherein P is a group selected from the group consisting of the formulae (P-1) to (P-7), as defined above, or more preferably of the formulae (P-1), (P-5), and (P-7).

In the second invention's embodiment, i.e. when the active enone is a therapeutical ingredient, there will be preferably used a releasing moiety (I) wherein P is a group of formula (P-13) or (P-14) 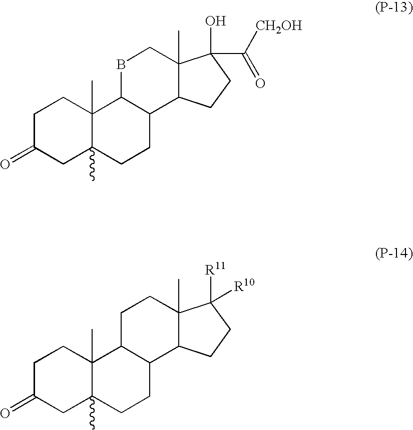
in the form of any one of their isomers, and wherein, R¹⁰ and R¹¹ having the meaning indicated above and B representing a C═O or CH₂OH group.

Independently of the exact nature of P, in the invention's delivery systems described above, the X group is preferably selected from the group consisting of formulae i), ii) and iii), as defined above, R⁶ representing a hydrogen atom or a methyl or ethyl group. More preferably, X represents a group of formula ii) or iii), as defined above, R⁶ representing a hydrogen atom or a methyl or ethyl group.

Furthermore, in the delivery systems described above, preferably, R represents a linear, branched or cyclic divalent or trivalent group derived from a C₂-C₉ alkyl group, the group optionally containing one or two functional groups selected from the group consisting of oxygen and sulfur atoms, COO, CONR⁶, and N(R⁶)ₐ, R⁶ being defined as above and a representing 0 or 1, R⁵ represents a methyl, ethyl or propyl group, and m is 1 or 2.

More preferably, R represents a linear, branched or cyclic divalent group derived from a C₂-C₆ alkyl group optionally containing one functional groups selected from the group consisting of oxygen and sulfur atoms, COO, and N(R⁶)ₐ, R⁶ being defined as above and a being 1, R⁵ represents a methyl, ethyl or propyl group, and m is 1.

According a particular mode of realisation of the invention, the invention's delivery system is one wherein P is a radical of formula (P-1) or (P-7), as defined above;

X represents a functional group of formula ii) or iii), R⁶ representing a hydrogen atom;

R represents a linear or branched divalent group derived from a C₂-C₆ alkyl group;

R⁵ represents a methyl, ethyl or propyl group; and m is 1, and n represents 1, 2 or 3.

Alternatively, a further particularly appreciated delivery system is one wherein P is a group of formula (P-2) as defined above, X represents a functional group of formula ii), R represents a linear or branched divalent group derived from a C₂-C₆ alkyl group, R⁵ represents a methyl, ethyl or propyl group, m is 1, and n represents an integer comprised between 1 to 3.

Independently from the embodiment of the invention, it is understood that whereas the invention's delivery system comprises more than one releasing moiety, then each of the various P may be identical or different, as well as each of the X, R, R⁵ or R⁶ groups.

The delivery system according to the invention may be synthesized using conventional methods. Indeed, the delivery system corresponding to any of the invention's embodiments is obtainable by a process comprising the reaction between a nano particle, as described above, with at least one molar equivalent of a compound of formula
(P—X)ₘ—R—Si(OR⁵)₃ (III)
wherein m, P, X, R and R⁵ have the meaning indicated above;
the reaction being carried out in a solvent having a dielectric constant ε comprised between 3 and 81, at a temperature comprised between 20° and 70° C. Optionally, the reaction can be carried out in the presence of a weak acid or base.

Alternatively, the invention's delivery system is also obtainable by a process comprising the reaction between a nano particle together with at least one molar equivalent of a compound of formula
(Y)ₘ—R—Si(OR⁵)₃ (III′)
wherein Y is a XH or COOR⁶ functional group or represents a C₅-C₇ carboxylic anhydride, and X, m, R, R⁵ and R⁶ have the same meaning as indicated above;
to obtain a derivatized nano particle, which is subsequently reacted with a compound of formula (IV) or (IV′) as defined below, under reactions conditions similar to those susceptible of leading to a Michael addition, i.e. conditions which are for instance used in the preparation of compounds (III) and which are described further below.

According to a particular embodiment of the invention, the first method of preparation is preferred.

It has been mentioned above, that the invention delivery system comprises at least one releasing moiety, and in the preparation of the delivery system a nano particle is reacted with at least one molar equivalent of the compound of formula (III) or (III′). For sake of clarity, it has to be mentioned that by “at least one” it is meant here an amount comprised between 1 and y, y representing ideally the maximum number of releasing moieties or molar equivalent which can be covalently bonded to the nano particle. As a person skilled in the art is aware, it is not possible to give an exact value to y. Indeed, the maximum number of releasing moieties, which can be attached to the nano particle, will depend on the surface of the nano particle used and on the volume of the releasing moieties.

As non-limiting examples, one can cite invention delivery systems wherein the nano particle moiety is covalently bonded to up to 2.2 releasing moieties per nm² of free surface area of the nano particles moiety (at a surface area of 50 m²/g this corresponds to 1.1×10²⁰ releasing moieties per gram of starting nano particle).

Suitable solvents for the synthesis of the invention's delivery system are water, linear, branched or cyclic mono-, di-, tri-, oligo- and polyalcohols with a monomer chain length of C₁ to C₁₅, preferably from C₁ to C₅, or C₁ to C₈ ketones, esters, ethers, carbon acids or yet mixtures thereof. As non limiting examples one may cite the solvents selected from the group consisting of water, ethanol, methanol, n-propanol, iso-propanol, n-decanol, dimethyl-ether, methyl-ethyl-ether, glycerol, dipropyl-glycol, 1,2-ethandiol, polyvinylalcohol.

If desired it is possible to use an organic or inorganic acid or base. As non-limiting examples one may cite acids like hydrochloric acid, acetic acid, citric acid and bases like ammonia, sodium hydroxide, potassium hydroxide, tetramethyl ammonium hydroxide for the synthesis of the invention's delivery system.

The compounds of formula (III) can be prepared using conventional methods, as illustrated herein below and in the examples.

For instance, the compounds (III) wherein X represents a sulfur atom, an oxygen atom or a NR⁶ group are obtainable by the [1,4]-addition reaction, optionally in the presence of a base, between a thiol, alcohol or respectively an amine, of general formula (H—X)ₘ—R—Si(OR⁵)₃ such as one of formula HSRSi(OR⁵)₃, HORSi(OR⁵)₃ or HNR⁶RSi(OR⁵)₃, and the active enone to be released by the invention's delivery systems, for instance an odoriferous α,β-unsaturated ketone, aldehyde or carboxylic ester of formula (IV) 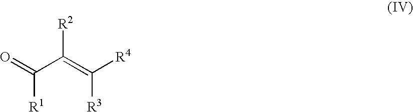
wherein R, R¹, R², R³, R⁴, R⁵ and R⁶ have the meaning indicated above and the configuration of the carbon-carbon double bond can be of the E or Z type.

The compounds of formula (III) wherein X is a functional group of formula v) or vi) are obtainable, using standard methods, by oxidation of the corresponding system in which X is a sulfur atom.

Furthermore, the compounds of formula (III) wherein X represents a carboxylic functional group can be obtained more advantageously by the reaction between an appropriate compound of formula (III′), such as ClCORSi(OR⁵)₃ or EtOCORSi(OR⁵)₃, and a compound of formula (IV′), which is the aldol derivative of the odoriferous compound of formula (IV), 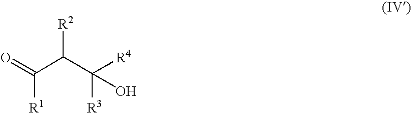
R, R¹, R², R³, R⁴ and R⁵ having the meaning indicated above.

The compounds of formula (III′) are generally commercially available or obtainable according to standard methods which are well known by a person skilled in the art.

Examples of the synthetic approach described above, for particular cases of starting materials, are illustrated in the following scheme:

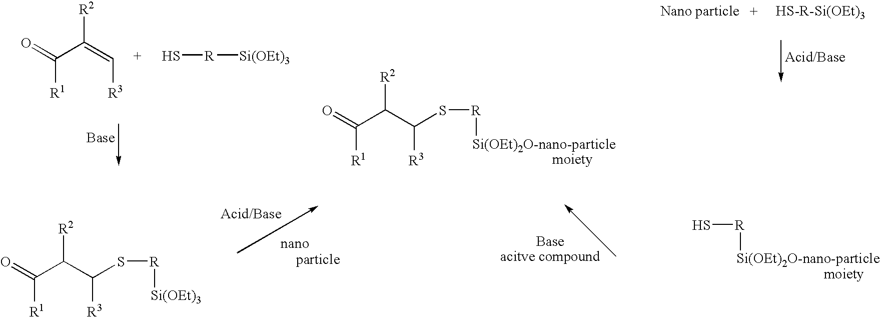

A particular example can be for instance the following:

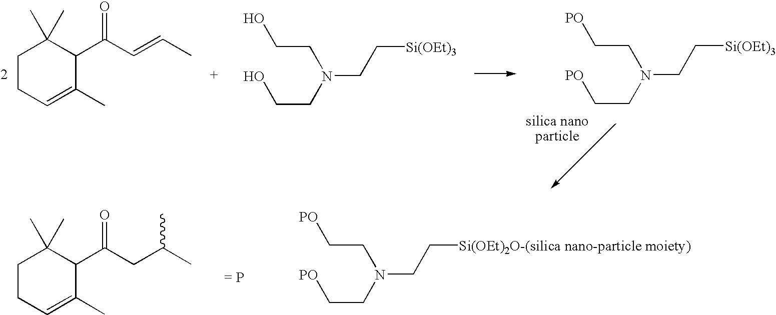

Although it is not necessary to provide an exhaustive list of the compounds of formula (H—X)ₘRSi(OR⁵)₃ or of formula (III′) which may be used in the synthesis of the various intermediates or delivery systems, one can cite as preferred examples the thiols of formula (R⁵O)₃Si—(CH₂)₁₋₃—SH, the amines of the formulae (R⁵O)₃Si—(CH₂)₃₋₄—NH₂, (R⁵O)₃Si—(CH₂)₂₋₃—NH—(CH₂)₂₋₆—NH₂, (R⁵O)₃Si—(CH₂)₂₋₃—N[—(CH₂)₂₋₆—NH₂]₂, (R⁵O)₃Si—(CH₂)₁₋₂—(CHMe)₁₋₂—(CH₂)₁₋₂—NH₂, (R⁵O)₃Si—(CH₂)₂₋₃—(C₆H₄)—(CH₂)₁₋₂—NH₂ or (R⁵O)₃Si—(CH₂)₂₋₃—(C₆H₄)—(CH₂)₁₋₂—NH—(CH₂)₂₋₃—NH₂, the alcohols of the formulae (R⁵O)₃Si—(CH₂)₁₋₃—OH, (R⁵O)₃Si—(CH₂)₂₋₃—N[—(CH₂)₂₋₆—OH]₂ or (R⁵O)₃Si—(CH₂)₂₋₃—NCO—(CH₂)₁₋₄—OH, or the esters or anhydrides of the formulae (R⁵O)₃Si—(CH₂)₂₋₃—CH(COOR⁶)₂ or (R⁵O)₃Si—(CH₂)₂₋₃-(2,5-dioxo-furan-3-yl), R⁵ and R⁶ having the same meaning as indicated above.

More preferably, one may cite in particular the thiols of the formulae (EtO)₃Si—(CH₂)₁₋₃—SH or (MeO)₃Si(CH₂)₁₋₃—SH, the amines of the formulae (MeO)₃Si(CH₂)₃₋₄—NH₂, (EtO)₃Si—(CH₂)₃₋₄—NH₂, (MeO)₃Si—(CH₂)₃—NH—(CH₂)_{2 or 6}—NH₂, (MeO)₃Si—(CH₂)₃—N[—(CH₂)_{2 or 6}—NH₂]₂, (MeO)₃Si—CH₂CHMe—(CH₂)₂—NH₂, (MeO)₃Si—(CH₂)₂—(C₆H₄)—CH₂NH₂ or (R⁵O)₃Si—(CH₂)₂—(C₆H₄)—CH₂NH—(CH₂)₂₋₃—NH₂.

Similarly, it is not possible to provide an exhaustive list of the currently active enones of formula (IV) which can be used in the synthesis of the invention's delivery systems, and subsequently be released. However, in the case where the compounds of formula (IV) are odoriferous enones, the following can be named as preferred examples: alpha-damascone, (−)-alpha-damascone, beta-damascone, gamma-damascone, delta-damascone, trans-delta-damascone, alpha-ionone, beta-ionone, gamma-ionone, delta-ionone, beta-damascenone, 3-methyl-5-propyl-2-cyclohexen-1-one, 1(6),8-P-menthadien-2-one, 2,5-dimethyl-5-phenyl-1-hexen-3-one, 1-(5,5-dimethyl-1-cyclohexen-1-yl)-4-penten-1-one, 8 or 10-methyl-alpha-ionone, 2-octenal, 1-(2,2,3,6-tetramethyl-1-cyclohexyl)-2-buten-1-one, 4-(2,2,3,6-tetramethyl-1-cyclohexyl)-3-buten-2-one, 2-cyclopentadecen-1-one, nootkatone, cinnamic aldehyde, 2,6,6-trimethyl-bicyclo[3.1.1]heptane-3-spiro-2′-cyclohexen-4′-one, ethyl 2,4-deca-dienoate, ethyl 2-octenoate, methyl 2-nonenoate, ethyl 2,4-undecadienoate and methyl 5,9-dimethyl-2,4,8-decatrienoate. Of course, the aldol derivatives of formula (IV′) of the latter compounds are also useful in the synthesis of the invention compounds.

Amongst the odoriferous compounds cited in the list hereinabove, the preferred are: α-damascone, (−)-alpha-damascone, β-damascone, γ-damascone, δ-damascone, trans δ-damascone, α-ionone, β-ionone, β-damascenone, 1-(5,5-dimethyl-1-cyclohexen-1-yl)-4-penten-1-one, 1-(2,2,3,6-tetramethyl-1-cyclohexyl)-2-buten-1-one, 4-(2,2,3,6-tetramethyl-1-cyclohexyl)-3-buten-2-one or its trans isomer, 1(6),8-P-menthadien-2-one, and 2-cyclopentadecen-1-one.

As it has been mentioned in the description above, the delivery system of the invention is composed of two main moieties, namely a nano particle moiety and a releasing moiety. Now, the latter moiety comprises a release part P—X and a linker part R—Si(OR⁵)₃₋ₙ(O→)ₙ.

Owing to the particular chemical structure of the release part P—X the invention's delivery systems are capable of releasing, via a decomposition reaction, a residue and an active enone of formula (IV).

An example of the decomposition reaction is illustrated in the following scheme: 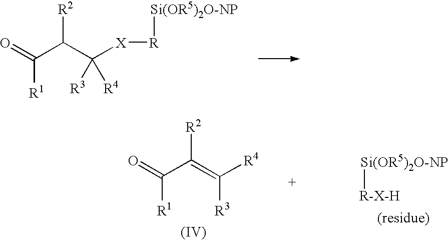
wherein X, R, R¹, R², R³ and R⁴ have the meaning indicated above and NP stand for nano particle moiety.

The nature of X plays an important role in the release kinetics of the active molecule. Thus, through a careful choice of the nature of X it is possible to tune the release properties of the invention's delivery systems.

The second part of the releasing moiety of the delivery system of the invention is the linker R—Si(OR⁵)₃₋ₙ(O→)ₙ. Besides its role as a linker between the releasing part P—X and the nano particle moiety, the linker part can have also an influence in the releasing properties of the invention's delivery system. Indeed, a shrewd choice of the chemical nature of the fragment, e.g. more or less flexible or hydrophobic/hydrophilic fragments, can allow to fine tune the perfume releasing properties.

The second moiety of the invention's delivery system is the nano particle moiety. If the invention's delivery system is intended to release a perfuming ingredient, according to a preferred embodiment of the invention, the moiety plays an important role in the effective deposition of the pro-perfume onto a surface and in surface substantivity of the invention's delivery system on the surface treated during an application, especially on fabrics and hair. Moreover it plays a capital role as regards the stability of the product into which the invention's delivery system may be incorporated, avoiding the problems of the above mentioned prior art pro-perfume systems, wherein the pro-perfume was at least partially adsorbed onto silica pores.

The decomposition reaction, which leads to the release of the active enone, is believed to be influenced by pH changes or heat, but may be triggered by other types of mechanisms.

As the delivery system of the invention can be a useful ingredient for the perfuming of various products or surfaces, the invention concerns also the use of a invention's delivery system as perfuming ingredients. In other words it concerns a method to confer, enhance, improve or modify the odor properties of a perfuming composition or of a perfumed article, which method comprises adding to the composition or article an effective amount of at least an invention's delivery system. By “use of an invention's delivery system” it has to be understood here also the use of any composition containing the delivery system and which can be advantageously employed in perfumery industry as active ingredients.

The compositions, which in fact can be advantageously employed as perfuming ingredient, are also an object of the present invention.

Therefore, another object of the present invention is a perfuming composition comprising:
i) as perfuming ingredient, at least an invention's delivery system of formula (I) as defined above, provided that P is a group of formula (II) as defined above;
ii) at least one ingredient selected from the group consisting of a perfumery carrier and a perfumery base; and
iii) optionally at least one perfumery adjuvant.

By “perfumery carrier” we mean here a material which is practically neutral from a perfumery point of view, i.e. that does not significantly alter the organoleptic properties of perfuming ingredients. The carrier may be a liquid.

As liquid carrier one may cite, as non-limiting examples, an emulsifying system, i.e. a solvent and a surfactant system, or a solvent commonly used in perfumery. A detailed description of the nature and type of solvents commonly used in perfumery cannot be exhaustive. However, one can cite as non-limiting example solvents such as dipropyleneglycol, diethyl phthalate, isopropyl myristate, benzyl benzoate, 2-(2-ethoxyethoxy)-1-ethanol or ethyl citrate, which are the most commonly used. Another example of suitable liquid carrier is water or a water-based medium.

Generally speaking, by “perfumery base” we mean here a composition comprising at least one perfuming co-ingredient.

The perfuming co-ingredient is not an invention's delivery system. Moreover, by “perfuming co-ingredient” it is meant here a compound, which is used in perfuming preparation or composition to impart a hedonic effect. In other words such a co-ingredient, to be considered as being a perfuming one, must be recognized by a person skilled in the art as being able to impart or modify in a positive or pleasant way the odor of a composition, and not just as having an odor.

The nature and type of the perfuming co-ingredients present in the base do not warrant a more detailed description here, which in any case would not be exhaustive, the skilled person being able to select them on the basis of its general knowledge and according to intended use or application and the desired organoleptic effect. In general terms, these perfuming co-ingredients belong to chemical classes as varied as alcohols, aldehydes, ketones, esters, ethers, acetates, nitrites, terpene hydrocarbons, nitrogenous or sulphurous heterocyclic compounds and essential oils, and the perfuming co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of perfumery. It is also understood that the co-ingredients may also be compounds known to release in a controlled manner various types of perfuming compounds.

For the compositions which comprise both a perfumery carrier and a perfumery base, other suitable perfumery carrier, than those previously specified, can be also ethanol, water/ethanol mixtures, limonene or other terpenes, isoparaffins such as those known under the trademark ISOPAR® (origin: Exxon Chemical) or glycol ethers and glycol ether esters such as those known under the trademark DOWANOL® (origin: Dow Chemical Company).

Generally speaking, by “perfumery adjuvant” we mean here an ingredient capable of imparting additional added benefit such as a color, a particular light resistance, chemical stability and etc. A detailed description of the nature and type of adjuvant commonly used in perfuming bases cannot be exhaustive, but it has to be mentioned that the ingredients are well known to a person skilled in the art.

An invention's composition consisting of at least one compound of formula (I) and at least one perfumery carrier represents a particular embodiment of the invention as well as a perfuming composition comprising at least one compound of formula (I), at least one perfumery carrier, at least one perfumery base, and optionally at least one perfumery adjuvant.

Moreover, according to a particular embodiment of the invention, a particular perfuming composition comprises:
i) as perfuming ingredient, at least an invention's delivery system as defined above, provided that P is a group of formula (II) as defined above;
ii) water; and
iii) optionally at least an anti-floculant ingredient.

Anti-floculant ingredients are compound well known per se by a person skilled in the art. By means of examples a suitable anti-floculant ingredient is the high molecular weigh co-polymer known under the name Disperbyk-190 (origin: Byk Chemie).

It is also useful to mention here that the possibility to have, in the compositions of matter mentioned above more than one invention's delivery system is important, as it enables the perfumer to prepare accords and perfumes, capable of releasing the odor tonality of various compounds of formula (IV) used in the preparation of the invention's system, creating thus new tools for their work.

Its is also understood here that, unless otherwise indicated or described, any mixture resulting directly from a chemical synthesis, e.g. without an adequate purification, in which the compound of the invention would be involved as a starting, intermediate or end-product could not be considered as a perfuming composition according to the invention.

As previously mentioned, an invention's delivery system, in any of its above-mentioned forms, is a useful perfuming ingredient which can be advantageously used in all the fields of modern perfumery, such as fine perfumery or functional perfumery, as it enables a controlled release of odoriferous molecules.

Indeed, the invention's delivery system may be advantageously employed in fine or functional perfumery to achieve a more controlled deposition and/or release, of an active perfuming ingredient. For example, perfuming ingredients present as such in washing or perfuming compositions can have little staying-power on a surface and consequently be often eliminated, for example in the rinsing water or upon drying of the surface. This problem can be solved by using an invention's delivery system, for which we have been able to show that it possesses a surprising stability over storage and staying-power or tenacity on surfaces such as textiles. Therefore, the invention's delivery system, owing to a good substantivity, a low volatility and a controlled release of odoriferous molecules, can be incorporated in any application requiring the effect of rapid or prolonged release of an odoriferous component as defined hereinabove and furthermore can impart a fragrance and a freshness to a treated surface which will last well beyond the rinsing and/or drying processes. Suitable surfaces are, in particular, textiles, hard surfaces, hair and skin.

Thus, in perfumery, one of the major advantages of the invention resides in the fact that the invention's delivery system imparts an intense fragrance to the treated surface, produced by an odoriferous enone, which would not be detected on the surface over a sufficiently long period if the α,β-unsaturated carbonyl derivative of formula (IV) had been used as such, i.e. without a precursor.

Therefore, another object of the present invention is a perfumed article comprising:
i) as perfuming ingredient at least one invention's delivery system as defined above, provided that P is a group of formula (II) as defined above; and
ii) a consumer product base;
   is also an object of the present invention.

For the sake of clarity, it has to be mentioned that, by “consumer product base” we mean here a consumer product, i.e. a consumable product such as a detergent or a perfume. In other words, a perfumed article according to the invention comprises the functional formulation, as well as optionally additional benefit agents, corresponding to a consumer product, e.g. a detergent or an air freshener, and an olfactive effective amount of at least one invention's delivery system.

The nature and type of the constituents of the consumer product do not warrant a more detailed description here, which in any case would not be exhaustive, the skilled person being able to select them on the basis of its general knowledge and according to the nature and the desired effect of the product.

Examples of suitable perfumed articles include solid or liquid detergents and fabric softeners as well as all the other articles of common use in perfumery, namely perfumes, colognes or after-shave lotions, perfumed soaps, shower or bath salts, mousses, oils or gels, hygiene products or hair care products such as shampoos, body-care products, deodorants or antiperspirants, air fresheners and also cosmetic preparations. As detergents there are intended applications such as detergent compositions or cleaning products for washing up or for cleaning various surfaces, e.g. intended for textile, dish or hard-surface treatment, whether they are intended for domestic or industrial use. Other perfumed articles are fabric refreshers, ironing waters, papers, wipes or bleaches.

Preferred articles are perfumes, fabric detergents or softener bases.

Typical examples of fabric detergents or softener compositions into which the compounds of the invention can be incorporated are described in WO 97/34986 or in U.S. Pat. Nos. 4,137,180 and 5,236,615 or EP 799 885. Other typical detergent and softening compositions which can be used are described in works such as Ullman's Encyclopedia of Industrial Chemistry, vol. A8, pages 315-448 (1987) and vol. A25, pages 747-817 (1994); Flick, Advanced Cleaning Product Formulations, Noye Publication, Park Ridge, N.J. (1989); Showell, in Surfactant Science Series, vol. 71: Powdered Detergents, Marcel Dekker, New York (1988); Proceedings of the World Conference on Detergents (4th, 1998, Montreux, Switzerland), AOCS print.

Some of the above-mentioned articles may represent an aggressive medium for the invention's delivery system, so that it may be necessary to protect the latter from premature decomposition, for example by encapsulation.

The proportions in which the delivery system according, wherein P is derived from an active perfuming ingredient, to the invention can be incorporated into the various aforementioned articles or compositions vary within a wide range of values. These values are dependent upon the nature of the article or product to be perfumed and on the desired olfactory effect as well as on the nature of the co-ingredients in a given composition when the invention's delivery system is mixed with perfuming coingredients, solvents or additives commonly used in the art. For example, typical concentrations are in the order of 0.1% to 5% by weight, or even up to 10% of invention's delivery system based on the weight of the composition into which it is incorporated. Concentrations lower than these, such as of the order of 0.01% to 1% by weight, can be used when the present delivery systems are applied directly in the perfuming of the various consumer products mentioned hereinabove.

A further object of the present invention concerns the use of a delivery system as defined above, wherein P is derived from an active therapeutical steroid, as a pharmaceutical agent. Furthermore, the present invention concerns also a pharmaceutical composition comprising a delivery system according to the second main embodiment of the invention.

### EXAMPLES

The invention will now be described in further detail by way of the following examples, wherein the abbreviations have the usual meaning in the art, the temperatures are indicated in degrees centigrade (° C.); the NMR spectral data were recorded in CDCl₃ (if not stated otherwise) with a 360 or 400 MHz machine for ¹H and ¹³C, the chemical displacement δ are indicated in ppm with respect to the TMS as standard, the coupling constants J are expressed in Hz.

### Example 1

Synthesis of Compounds of Formula (III)

### a) Synthesis of (±)-3-{[3-(triethoxysilyl)propyl]thio}-1-(2,6,6-trimethyl-2-cyclohexen-1-yl)-1-butanone

To a stirred solution of α-damascone (9.60 g, 50.0 mmol) and DBU (1.52 g, 10.0 mmol) in THF (40 ml), was rapidly added, at 25-40°, 3-mercaptopropyl-triethoxysilane (95% pure from ABCR, 12.52 g, 50.0 mmol). After 2 h, the reaction mixture was poured onto cold 5% aqueous HCl solution and extracted twice with Et₂O. The organic phases were washed (H₂O, saturated aqueous NaHCO₃ solution and saturated aqueous NaCl solution), dried (Na₂SO₄), filtered and concentrated. The crude extract was dried 1 hour at 65-70°/1 Pa to give 21.20 g of thioether (pale yellow oil, diastereomeric mixture ca. 55:45, yield=98.5%).

¹H-NMR (major diastereomer): 0.74 (t, J=8.5, 2H), 0.9 (s, 3H), 0.92 (s, 3H), 1.22 (t, J=7.0, 9H), 1.28 (t, J=7.0, 3H), 1.6 (s, 3H), 1.71 (m, 4H), 2.15 (m, 2H), 2.52-2.94 (m, 5H), 2.28 (m, 1H), 3.81 (q, J=7.0, 6H), 5.59 (s, 1H)

¹³C-NMR (major diastereomer): 211.0 (s), 130.0 (s), 123.7 (d), 63.7 (d), 58.4 (t), 53.2 (t), 34.4 (d), 33.9 (t), 32.5 (s), 30.8 (t), 28.0 (q), 27.8 (q), 23.5 (q), 23.4 (t), 21.6 (q), 22.6 (t), 18.3 (q), 10.1 (t)

### b) Synthesis of (±)-4-{[3-trimethoxysilyl)propyl]/thio}-4-(2,6,6-trimethyl-1-cyclohexen-1-yl)-2-butanone

To a well-stirred mixture of β-ionone (10.00 g, 52.1 mmol) and DBU (79.20 mg, 0.52 mmol) was rapidly added at 25-30° (cooling bath: 15°) 3-mercaptopropyl-trimethoxysilane (10.21 g from ABCR, 52.1 mmol). After 72 h, the reaction mixture was poured onto a cold stirred 5% aqueous HCl solution and extracted twice with Et₂O. The organic phases were washed (H₂O, saturated aqueous NaHCO₃ solution and saturated aqueous NaCl solution), dried (Na₂SO₄), filtered and concentrated. The crude extract was dried 1 h at 65-70°/1 Pa to gave 18.00 g of thioether (pale yellow oil, containing by ¹H-NMR ca. 10% of β-ionone, yield=80%).

¹H-NMR: 0.74 (dt, J=3.5 and 8.5, 2H), 0.94 (s, 3H), 1.15 (s, 3H), 1.35-1.74 (m, 6H), 1.80 (s, 3H), 1.91 (m, 2H), 2.17 (s, 3H), 2.58 (m, 2H), 2.88 (dd, J=3.5 and 18.0, 1H), 3.28 (dd, J=8.0 and 18.0, 1H), 3.56 (s, 9H), 3.99 (dd, J=3.5 and 8.0, 1H)

¹³C-NMR: 206.6 (s), 139.9 (s); 131.6 (s), 53.2 (t), 50.5 (q), 39.8 (t), 38.1 (d), 37.0 (t), 35.8 (s), 33.7 (t), 30.7 (q), 28.3 (q), 27.9 (q), 22.8 (t), 22.4 (q), 19.3 (t), 8.8 (t)

### c) Synthesis of (±)-3-{[3-(triethoxysilyl)propyl]amino}-1-(2,6,6-trimethyl-2-cyclohexen-1-yl)-1-butanone

α-Damascone (9.60 g; 50 mmol) diluted in Et₂O (50 ml) was treated at 20° C. with an excess of 3-aminopropyl-triethoxysilane (16.70 g; 75 mmol). The reaction was slightly exothermic, the stirring was continued during 2 days at 20°.

The mixture was concentrated on a vacuum rotator and distilled at 10 Pa with a Vigreux column. The distillation (b.p. 49°-52°) allowed to obtain 17.1 g of the title compound (diastereomeric mixture ca. 60:40, yield=82%).

¹H-NMR (major diastereomer): 0.62-0.66 (m, 2H), 0.90 (s, 3H), 0.92 (s, 3H), 1.05 and 1.08 (d, J=6 Hz, 3H), 1.11-1.19 (m, 1H), 1.22 (t, J=7 Hz, 9H), 1.53-1.62 (m, 3H), 1.58 (broad s, 3H), 1.68-1.78 (m, 1H), 1.98-2.16 (m, 2H), 2.47-2.74 (m, 5H), 3.07-3.16 (m, 1H) 3.81 (q, J=7 HZ, 6H), 5.58 (broad s, 1H).

¹³C-NMR (major diastereomer): 213.4 (s), 130.0 (s), 123.6 (d), 63.8 (d), 58.3 (t), 53.0 (t), 50.1 (t), 48.8 (d), 32.4 (s), 30.7 (t), 28.1 (q), 27.8 (q), 23.5 (t), 23.5 (q), 22.7 (t), 20.4 (q), 18.3 (q), 8.1(t).

### d) Synthesis of (±)-trans-3-{[3-(triethoxysilyl)propyl]amino}-1-(2,6,6-trimethyl-3-cyclohexen-1-yl)-1-butanone

This product was obtained by using the same experimental procedure as described under c) and using (trans)-δ-Damascone as starting compound. The title compound was obtained by distillation (b.p. 10 Pa=49°-53°) in the form of a mixture of 80/20 mixture of two diastereomers. Yield=50%.

¹H-NMR (major diastereomer): 0.63-0.67 (m, 2H), 0.89 (d, J=7 Hz, 3H), 0.94 (s, 3H), 0.97 (s, 3H), 1.07 (d, J=6 Hz, 3H), 1.22 (t, J=7 Hz, 9H), 1.52-1.75 (m, 3H), 1.88-2.01 (m, 1H), 2.23 (d, J=11 Hz, 1H), 2.41-2.74 (m, 6H), 3.14 (q×t, J=6 and 6 Hz, 1H), 3.81 (q, J=7 Hz, 6H), 5.45 (broad d, J=10 Hz, 1H), 5.50-5.57 (m, 1H).

¹³C-NMR (major diastereomer): 214.6 (s), 131.9 (d), 124.1 (d), 63.0 (d), 58.4 (t), 55.0 (t), 50.1 (t), 48.5 (d), 41.8 (t), 33.1 (s), 31.6 (d), 29.8 (q), 23.6 (t), 20.7 (q), 20.4 (q), 20.0 (q), 18.3 (q), 8.1 (t).

### Example 2

Synthesis of Delivery Systems According to the Invention

### a) Preparation of the Starting Nano Particle

315 g tetraethoxysilane (1.27 mol) are mixed with 782 g ethanol (17 mol) (component 1). Separately, 21.23 g of a 35% w/w aqueous solution of ammonia were diluted with 498 g of water (component 2). Component 2 is mixed under vigorous stirring with component 1. The mixture thus obtained is heated up to 70° C. for 8 hours. Afterwards, to the mixture thus obtained were added 9.5 g of Polyoxyethylene sorbitan monooleate (Tween 80, origin ICI), and the mixture was heated under stirring in an autoclave for 4 hours at 230° C., while maintaining the pressure between 30 and 40 bar. To remove the precipitated powder from the solvent decanting and filter pressing has been used.

The so prepared SiO₂ powders have been mixed with 12% w/w, relative to the amount of powder, of the surface modifier Polyoxyethylene sorbitan monooleate (Tween 80), and dipropylene glycol was added. Then, the mixture was treated mechanically using a mortary mill and a 3 roller mill for about 1 to 5 hours (see below). This procedure gives a suspension of nano particles made of silica having a primary particle size comprised between 20 nm and 50 nm, and a specific surface area of about 40 m²/g to 50 m²/g. The dipropylene glycol can be removed, to recover a dry powder, by freeze drying process in a Christ Epsilon 2-60 at −10° C. for 24 hours.

Mortary mill: This is a milling machine form by a round Zirconium container. In this pot a round Zirconium pistil is set very close (2 μm) to one side of the pot and is touching the bottom of the container. The container turns with 120 rpm while the pistil is pressed to the bottom of the container with a force of 10 N (1 kg). For this kind of treatment, one always needs a solvent with a boiling point beyond 100° C. Water for example will evaporate during the process due to the temperature created by the high shearing forces between container, pistil and suspension.

### b) Preparation of the Delivery System

### i) Delivery System Having a Releasing Moiety According to Example 1a

12.8 g pro-perfume according to example 1a) are mixed with 107.2 g dipropylene glycol. This mixture is placed into a mortary mill as described above. 131.5 g of freeze-dried nano particle obtained above are slowly added to the solution while the mortary mill is working with 120 rpm. The pressure on the pistil is 10 N. The mixture is mixed in the mill for 3 to 5 hours until a highly viscous solution is created.

The final product, which is a suspension of the invention delivery system in dipropylene glycol, has been analyzed using the Zeta sizer, see below. The starting nano particle has no Zero cross over at any pH value while the treated one has a Zero cross over at the pH value of 3. This is a certain indication that the pro-perfume has been bound chemically to the particle, otherwise the zeta potential would only slightly be changed in the measured pH range.

The density of the so modified material changed slightly to 2.27 g/cm³, while the surface area decreased to 37.4 m²/g. The particles did not grow during the modification process and still showed a main primary particle size of 20 to 50 nm.

### ii) Preparation of the Delivery System (Pro Perfume According to Example 1b)

10.9 g pro-perfume according to example 1b) are mixed with 91.3 g dipropylene glycol. This mixture is placed into a mortary mill, container and pistil made of Zirconia. 111.9 g freeze-dried modified Silica powder is slowly added to the solution while the mortary mill is working with 120 rpm. The pressure on the pistil is 10 N. The mixture is treated for 3 to 5 hours until a highly viscous solution is created.

The final product has been analyzed using a Zeta sizer apparatus, which detects the surface charge of the particle solution dependent on the pH value. The untreated SiO₂ has no Zero cross over at any pH value while the treated one has a Zero cross over at the pH value of 3. This is a certain indication that the pro-perfume has been bound chemically to the particle, otherwise the zeta potential would only slightly be changed in the measured pH range. The density and the surface area of this invention's delivery system are similar to those of the one described in example 2.b.i).

### iii) Preparation of the Delivery System (Pro Perfume According to Example 1c)

10.9 g pro-perfume according to example 1c) are mixed with 91.3 g dipropylene glycol. This mixture is placed into a mortary mill, container and pistil made of Zirconia. 111.9 g freeze-dried modified Silica powder is slowly added to the solution while the mortary mill is working with 120 rpm. The pressure on the pistil is 10 N. The mixture is treated for 3 to 5 hours until a highly viscous solution is created.

The final product has been analyzed using a Zeta sizer apparatus, which detects the surface charge of the particle solution dependent on the pH value. The untreated SiO₂ has no Zero cross over at any pH value while the treated one has a Zero cross over at the pH value of 3. This is a certain indication that the pro-perfume has been bound chemically to the particle, otherwise the zeta potential would only slightly be changed in the measured pH range.

The density and the surface area of this invention's delivery system are similar to those of the one described in example 2.b.i).

### iv) Preparation of the Delivery System (Pro Perfume According to Example 1d)

10.9 g pro-perfume according to example 1d) are mixed with 91.3 g dipropylene glycol. This mixture is placed into a mortary mill, container and pistil made of Zirconia. 111.9 g freeze-dried modified Silica powder is slowly added to the solution while the mortary mill is working with 120 rpm. The pressure on the pistil is 10 N. The mixture is treated for 3 to 5 hours until a highly viscous solution is created.

The final product has been analyzed using a Zeta sizer apparatus, which detects the surface charge of the particle solution dependent on the pH value. The untreated SiO₂ has no Zero cross over at any pH value while the treated one has a Zero cross over at the pH value of 3. This is a certain indication that the pro-perfume has been bound chemically to the particle, otherwise the zeta potential would only slightly be changed in the measured pH range.

The density and the surface area of this invention's delivery system are similar to those of the one described in example 2.b.i).

### Example 3

A Granular Fabric Detergent Base Containing an Invention Delivery System

General Procedure

A dispersion of a delivery system according to the invention in DIPG^{C)}, respectively an amount of free active compound (see Table 1), were added to 85 g of unperfumed market powder detergent “Via” (Lever Fabergé AB, Stockholm, Sweden). After mixing, the perfumed detergent was introduced in the powder compartment of a Miele Novotronic W900-79 CH washing machine. No fabric-softener was used. The machine was loaded with 16 terry towels (28×28 cm, about 40 g each) and approx. 2.3 kg of cotton towels (11 towels, sized 45×85 cm). This load was washed at 40° C. using the normal cycle program and setting the spin drying adjustment to 900 rpm. After completion of the washing program, the 16 terry towels were line-dried, in a drying room for 24 hours before being evaluated by a 20 people panel. They were then packed loosely in aluminum foil and further evaluated by a 20 people panel after 1, 4 and 7 days.

Each panelist was asked to rate the various terry towels tested on an intensity scale of 1 to 7. 1: no odor, 2: weak odor, 3: slightly weak odor, 4: medium odor, 5: slightly strong odor, 6: strong odor, 7: very strong odor.

As reference, there was used an amount of active compound of formula (IV), i.e. in this case alpha-damascone or alpha-ionone, corresponding to the total amount which could be theoretically released by the invention's delivery system used.

TABLE 1
Average value of the intensity rated by panelists over 7 days

| | | Amount of | Average |
|---|---|---|---|
| Tested compound or delivery | Description of nano | perfume | intensity on |
| system | dispersion applied | applied | dry fabric ^{a)} |
| 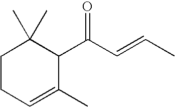 | | 98 mg | 3.8 |
| reference: α-damascone | | | |
| 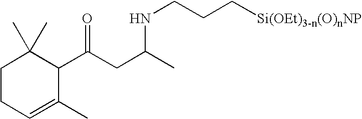 | 7.3 g of delivery system in the form of a 30% w/w dispersion in DIPG ^{c)}. | 98 mg | 4.0 |
| 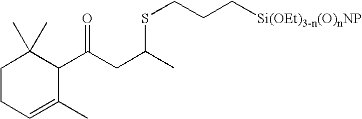 | 6.4 g of delivery system in the form of a 30% w/w dispersion in DIPG ^{c)}. | 98 mg | 4.6 |

^{a} average of days 1 to 7

b) Theoretical amount of available active compound

c) DIPG: dipropylene glycol

As can be seen from Table 1, both delivery systems according to the invention are able to impart to a fabric a significantly more intense odor, than the active compound as such. This effect being present over a long period of time.

### Example 4

A Concentrated Fabric Softener Base Containing an Invention Delivery System

A concentrated fabric softener base was prepared by admixing the following ingredients:

| Ingredient | Parts by weight |
|---|---|
| STEPANTEX ® VS 90 diester quat¹⁾ | 16.5 |
| Calcium chloride | 0.2 |
| Deionised water | 82.3 |
| | 100.0 |

¹⁾origin: Stepan Europe, France

The delivery system according to the invention, in the form of a dispersion in DIPG, was added to 36 g of fabric-softener base above. After a vigorous stirring the mixture was poured in the fabric-softener compartment of a Miele Novotronic W900-79 CH washing machine. No detergent is applied.

Then, 16 small terry towels (28×28 cm, about 40 g each) and 2.3 kg of large cotton towels (11 towels of 45×85 cm) were washed at 40° C. using the short cycle program and setting the spin drying adjustment to 900 rpm.

At the end of the wash, the 16 small terry towels were dried in a drying room for 24 hours and then packed loosely in aluminum foil and evaluated by a 20 people panel 3 days and 7 days after the wash.

Each panelist was asked to rate the various terry towels tested on an intensity scale of 1 to 7 (1: no odor, 2: weak odor, 3: slightly weak odor, 4: medium odor, 5: slightly strong odor, 6: strong odor, 7: very strong odor).

As reference was used a fabric-softener base containing the equimolar amount of free alpha-damascone, alpha-ionone or beta-ionone tested through the same process.

The results are summarized in the following table.

TABLE 2
Average intensity rating of all three evaluations on dry fabric
(1, 3 and 7 days after the wash)

| | | Amount of | Average |
|---|---|---|---|
| Tested compound or delivery | Description of nano | perfume | intensity on |
| system | dispersion applied | applied | dry fabric |
| 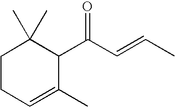 | | 72 mg | 2.8 |
| 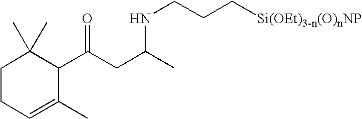 | 5.4 g of delivery system in the form of a 30% w/w dispersion in DIPG. | 72 mg | 4.4 |
| 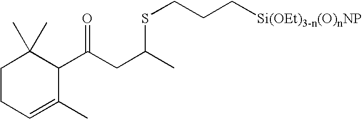 | 4.75 g of delivery system in the form of a 30% w/w dispersion in DIPG. | 72 mg | 4.9 |
| 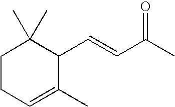 | | 72 mg | 3.2 |
| 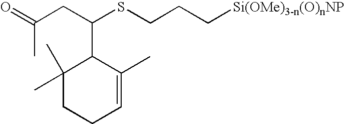 | 4.75 g of delivery system in the form of a 30% w/w dispersion in DIPG. | 72 mg | 4.6 |
| 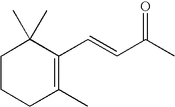 | | 72 mg | 3.1 |
| 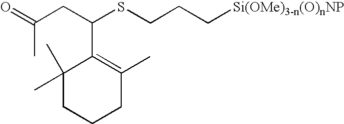 | 4.75 g of delivery system in the form of a 30% w/w dispersion in DIPG. | 72 mg | 4.3 |

What is claimed is:

1. A delivery system comprising an inorganic nano particle moiety covalently bonded by means of n (Si—O)— bonds to at least one releasing moiety of formula
(P—X)ₘ—R—Si(OR⁵)₃₋ₙ(O→)ₙ (I)
wherein the arrow indicates the location of the bond between the releasing moiety and the nano particle moiety, n representing an integer comprised between 1 to 3, and which
a) P represents a group derived from an active perfume ingredient and which is represented by formula (II) 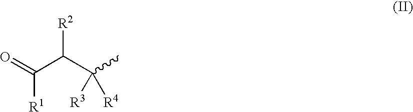
in which the wavy line indicates the location of the bond between the P and X;
R¹ represents a hydrogen atom, a C₁ to C₆ alkoxyl radical or a C₁ to C₁₅ linear or branched or cyclic alkyl, alkenyl or alkadienyl group, optionally substituted by one to four C₁ to C₄ alkyl groups; and
R², R³ and R⁴ represent a hydrogen atom, a C₆₋₈ aromatic ring or a C₁ to C₁₅ linear, cyclic or branched alkyl, alkenyl or alkadienyl group, optionally substituted by one to four C₁ to C₄ alkyl groups; two, or three, of the R¹ to R⁴ being optionally bonded together to form a saturated or unsaturated ring having 6 to 20 carbon atoms and including the carbon atom to which the R¹, R², R³ or R⁴ groups are bonded, this ring being optionally substituted by one to four C₁ to C₄ linear or branched alkyl or alkenyl groups;
or P represents a group derived from an active therapeutical steroid and is represented by formula 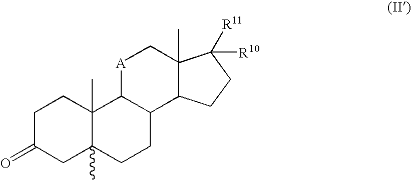
in which the wavy line indicates the location of the bond between the P and X;
R¹⁰ represents a hydrogen atom or a hydroxy group;
A represents a CH₂, C═O or CH₂OH group; and
R¹¹ represents a hydrogen atom or a C≡CH, CH₃CO or HOCH₂CO group;
b) X represents a functional group selected from the group consisting of the formulae i) to vi): 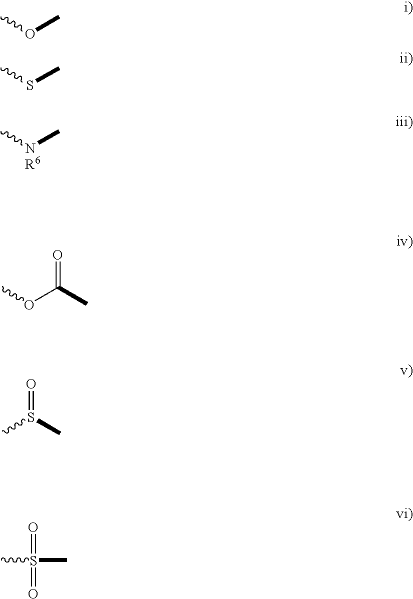
in which formulae the wavy lines are as defined previously and the bold lines indicate the location of the bond between the X and R, and R⁶ represents a hydrogen atom or a C₁ to C₄ alkyl group;
c) R represents a linear, branched or cyclic multivalent group (with a m+1 valence) derived from a C₁-C₁₅ alkyl or alkylaryl group, the group optionally containing one or two functional groups selected from the group consisting of oxygen and sulfur atoms, CO, COO, CONR⁶, COS and N(R⁶)ₐ, R⁶ being defined as above and a representing 0 or 1,
d) R⁵ represents a linear or branched C₁ to C₄ alkyl group; and
e) m represents 1, 2 or 3

2. A delivery system according to claim 1, characterised in that the inorganic nano particle is made from oxides or hydroxides of Ti, Si, Zr, Al, Fe or mixtures thereof.

3. A delivery system according to claim 1, wherein X is selected from the group consisting of formulae i), ii) and iii), R⁶ representing a hydrogen atom or a methyl or ethyl group.

4. A delivery system according to claim 1, wherein R represents a linear, branched or cyclic divalent or trivalent group derived from a C₂-C₉ alkyl group optionally containing one or two functional groups selected from the group consisting of oxygen and sulfur atoms, COO, CONR⁶, and N(R⁶)ₐ, R⁶ being defined as in claim 1 and a representing 0 or 1;
R⁵ represents a methyl, ethyl or propyl group; and
m is 1 or 2.

5. A delivery system according to claim 1, wherein P a is group selected from the group consisting of the formulae (P-1) to (P-12) 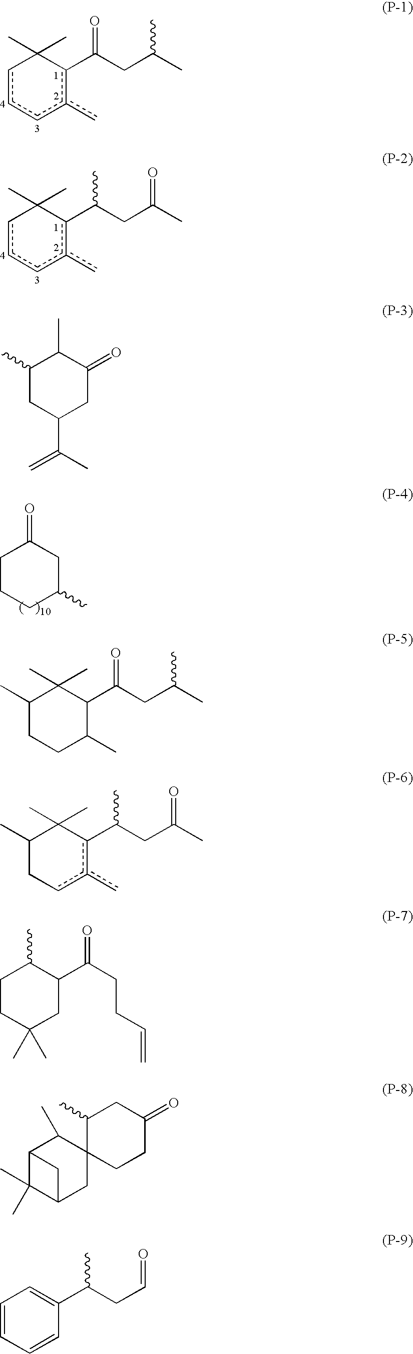 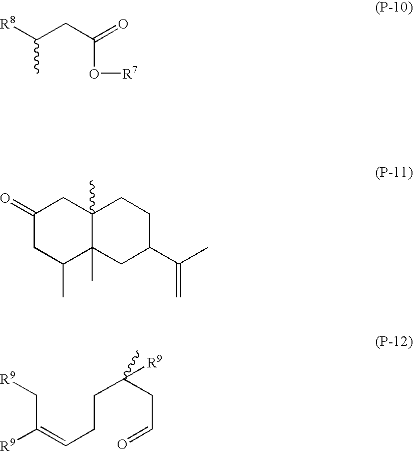
in the form of any one of their isomers, and wherein the dotted lines represent a single or double bond, R⁷ represents a methyl or ethyl group, R⁸ represents a C₆ to C₉ linear or branched alkyl, alkenyl or alkadienyl group and R⁹ represents a hydrogen atom or a methyl group, and the wavy lines have the meaning given in claim 1.

6. A delivery system according to claim 1, wherein P is a group derived from a therapeutical α,β-unsaturated steroid having from 19 to 26 carbon atoms.

7. A perfuming composition comprising:
i) as perfuming ingredient, at least a delivery system as defined in claim 1, provided that P is a group of formula (II) as in claim 1;
ii) at least one ingredient selected from the group consisting of a perfumery carrier and a perfumery base; and
iii) optionally at least one perfumery adjuvant.

8. A perfuming composition comprising:
i) as perfuming ingredient, at least a delivery system as defined in claim 1, provided that P is a group of formula (II) as in claim 1;
ii) water; and
iii) optionally at least an anti-floculant ingredient.

9. A perfuming composition comprising:
i) as perfuming ingredient, at least a delivery system as defined in claim 5, provided that P is a group of formula (II) as in claim 5;
ii) at least one ingredient selected from the group consisting of a perfumery carrier and a perfumery base; and
iii) optionally at least one perfumery adjuvant.

10. A perfuming composition comprising:
i) as perfuming ingredient, at least a delivery system as defined in claim 5, provided that P is a group of formula (II) as in claim 5;
ii) water; and
iii) optionally at least an anti-floculant ingredient.

11. A method to confer, enhance, improve or modify the odor properties of a perfuming composition or of a perfumed article, which method comprises adding to the composition or article an effective amount of at least a delivery system as defined in claim 1, provided that P is a group of formula (II) as in claim 1.

12. A method to confer, enhance, improve or modify the odor properties of a perfuming composition or of a perfumed article, which method comprises adding to the composition or article an effective amount of at least a delivery system as defined in claim 5, provided that P is a group of formula (II) as in claim 5.

13. A perfumed article comprising:
i) as perfuming ingredient, at least a delivery system as defined in claim 1, provided that P is a group of formula (II) as in claim 1;
ii) a consumer product base.

14. A perfumed article according to claim 13, wherein the consumer product base is in the form of a solid or liquid detergent, a fabric softener, a perfume, a cologne, an after-shave lotion, a perfumed soap, a shower or bath salt, mousse, oil or gel, a hygiene product, a hair care product, a shampoo, a body-care product, a deodorant, an antiperspirant, an air freshener, a cosmetic preparation, a fabric refresher, an ironing water, a paper, a wipe or a bleach.

15. A perfumed article comprising:
i) as perfuming ingredient, at least a delivery system as defined in claim 5, provided that P is a group of formula (II) as in claim 5;
ii) a consumer product base.

16. A perfumed article according to claim 15, wherein the consumer product base is in the form of a solid or liquid detergent, a fabric softener, a perfume, a cologne, an after-shave lotion, a perfumed soap, a shower or bath salt, mousse, oil or gel, a hygiene product, a hair care product, a shampoo, a body-care product, a deodorant, an antiperspirant, an air freshener, a cosmetic preparation, a fabric refresher, an ironing water, a paper, a wipe or a bleach.

17. A delivery system according to claim 6 which includes a therapeutic agent for delivery of same.

18. A pharmaceutical composition comprising a delivery system according to claim 6 and including a therapeutic agent.
